(19) United States
(12) Patent Application Publication
(10) Pub. No.: US 2011/0067681 A1
(43) Pub. Date: Mar. 24, 2011

(54) PAINTBALL LOADER REMOVABLE DRIVE SYSTEM

(75) Inventors: Simon STEVENS, Sewell, NJ (US); James T. CHRISTOPHER, Sachse, TX (US); Chris T. GODDARD, Aubrey, TX (US)

(73) Assignee: KEE ACTION SPORTS I LLC, Sewell, NJ (US)

(21) Appl. No.: 12/693,938

(22) Filed: Jan. 26, 2010

Related U.S. Application Data
(63) Continuation of application No. PCT/US2008/071381, filed on Jul. 28, 2008.
(60) Provisional application No. 60/952,034, filed on Jul. 26, 2007.

(51) Int. Cl. F41B 11/02; B23P 11/00

(52) U.S. Cl. 124/51.1; 29/426.1

(57) ABSTRACT

A loader for storing and delivering paintballs to a paintball marker comprising a removable drive unit. The drive unit is arranged within a cartridge configured to be received into a cavity provided within the body of the loader. This arrangement provides for the quick removal of the drive system from the loader, facilitating ease of repair, replacement, or upgrading of the drive unit.

### CROSS REFERENCE TO RELATED APPLICATION

This application is a continuation of International Application No. PCT/US2008/071381 filed Jul. 28, 2008, which claims priority to U.S. Provisional Patent Application No. 60/952,034, filed Jul. 26, 2007, the entire contents of all of which are incorporated by reference as if fully set forth.

### FIELD OF INVENTION

This invention relates to the field of projectile loaders for feeding projectiles into compressed gas guns, and in particular, to paintball loaders.

### BACKGROUND

The popular sport of paintball utilizes paintball markers (or guns) powered by compressed gas in order to fire projectiles. Some examples of paintball guns are those offered under the brand names 32 DEGREES™, EMPIRE™, DIABLO™, BT™ and INVERT MINI™, and others shown and described in U.S. Pat. Nos. 6,708,685; 4,936,282; 5,497,758; and U.S. patent application Ser. Nos. 11/183,548; 11/180,506; 11/150,002; 11/064,693; 10/313,465; 10/090,810, the entire contents of which are all incorporated fully herein by reference. Players use the paintball guns to shoot projectiles known as paintballs (projectiles and paintballs are used interchangeably herein). These paintballs are spherical, frangible projectiles normally having gelatin or starch-based shells filled with paint, coloring, or dye. The shells break when impacting a target, splattering the target with the paint contained therein. The sport of paintball is often played like capture the flag. A player is eliminated from the game when he or she is hit by a paintball fired from an opposing player's marker. When the paintball hits a target such as a player, a mark or “splat” of paint is left on the player.

Paintball loaders (otherwise known and used interchangeably herein as hoppers, magazines, projectile loaders or loaders) generally sit atop the markers and feed projectiles into the marker. These projectile loaders store projectiles and have an outlet or exit tube (outfeed tube or neck). The outlet tube is connected to an inlet tube (or feed neck) of the paintball marker, which is in communication with the breech of the marker. During the normal operation, paintballs dropped through the outlet of the loader form a paintball stack within the outlet tube and gun inlet tube. When the paintball at the bottom of the stack is dropped into the firing chamber of the paintball marker, it is replaced at the top of the stack from the supply of paintballs remaining in the loader housing, thereby replenishing the stack. Thus, the loaders act to hold and feed paintball projectiles into the breech of a paintball marker, so that the projectiles can be fired from the marker.

Many loaders contain agitators or feed systems to mix, propel, or otherwise move projectiles in the loader. This mixing is performed by an impeller, projection, drive cone, agitator, paddle, arm, fin, carrier, or any other suitable mechanism, such as those shown and described in U.S. patent application Ser. No. 12/171,956 and U.S. Pat. Nos. 6,213,110; 6,502,567; 5,947,100; 5,791,325; 5,954,042; 6,109,252; 6,889,680; and 6,792,933, the entire contents of all of which are incorporated by reference herein. In a “gravity feed” or “agitating” loader, an agitator mixes projectiles so that no jams occur at the exit opening of the outlet tube. In a “force feed” or “active feed” paintball loader, the agitator (drive cone, carrier, paddle or any other force feed drive system) forces projectiles through the exit tube. As the firing rates of paintball markers have increased, active feed loaders have become extremely popular due to their ability to ensure the proper feeding of projectiles and sustain the feed rates necessary to support today's markers.

Modern paintball loaders utilize projections, paddles, arms, carriers, drive cones, or other agitators to mix or advance paintballs. These agitators are operated by motors which are often controlled by an electronic control circuit. These control circuits may utilize microprocessors in conjunction with at least one sensor configured to detect any number of parameters, including the firing of a projectile from the marker or the occurrence of a jam. These components are typically powered by a D.C. power source, such as a battery.

As a result of the increasingly competitive nature of the sport, as well as the rapid development in related technology, components of these feed systems are frequently upgraded by a user in order to improve the characteristics of the loader and feed mechanism. Such upgrades may include replacing various components in order to improve the feed mechanism's battery life, or to increase the speed and/or adjustability of the drive system. However, because the agitators, control circuits, sensors, and drive mechanisms are traditionally enclosed inside the body of the paintball loader, these components can typically only be reached by partially or fully disassembling the loader. This arrangement results in difficult and time consuming maintenance, repair, and upgrade procedures.

Moreover, if a paintball breaks inside a paintball loader, there must be a convenient and efficient way to open the hopper and clean the paint or dye from the inside of the paintball hopper, without having to fully disassemble the loader.

Thus, there is the need for a paintball loader and feed mechanism that provides quick and complete access to the feed system components in order to facilitate maintenance, cleaning or upgrading.

### SUMMARY

The present invention relates to a paintball loader featuring a removable drive system. The loader comprises a paintball hopper having a cartridge receiving area and a corresponding removable drive cartridge. In a preferred embodiment, the drive cartridge houses a feed mechanism which is driven by a motor located within the drive cartridge. The drive cartridge is removably secured inside of the cartridge receiving area through the use of tabs, snap fits, flanges, magnets, or other suitable coupling means, ensuring that a cartridge can be repeatedly removed from and inserted into the cartridge cavity.

In another embodiment, an upper portion of the loader is hingedly attached to a lower portion containing the drive cartridge, wherein a user may access or remove the cartridge by pivoting the upper portion of the loader away from the lower portion.

In an alternate embodiment, a second drive cartridge having a second feed mechanism is inserted into the cartridge cavity as an upgrade or a replacement for the entire first drive cartridge.

In another embodiment, the feed mechanism and motor are controlled by a microprocessor, or another suitable controller, located inside of an electronics compartment arranged in the drive cartridge. The electronics compartment may also house a battery to power the motor and controller.

### BRIEF DESCRIPTION OF THE DRAWINGS

FIG. 1 is a side elevation view of a representative paintball loader operatively attached to a paintball marker.

FIG. 2 is an exploded view of an embodiment of the loader according to the present invention.

FIG. 3 is a cross-sectional view of a loader with the drive cartridge installed according to the present invention.

FIG. 4 is a cross-sectional view of an alternate embodiment of a loader according to the preset invention.

FIG. 5 is an isometric view of the loader of the present invention with the drive cartridge removed.

FIG. 6 is an isometric view of the loader of the present invention with the drive cartridge aligned for insertion into the cavity.

FIGS. 7 and 8 are isometric views of the loader of the present invention with the drive cartridge installed into the loader.

### DETAILED DESCRIPTION OF THE PREFERRED EMBODIMENTS

As used herein, the term loader, projectile loader, hopper, or magazine refer to any apparatus which stores projectiles for use in a paintball marker. As used herein, the terms “feeder”, “feed mechanism”, or “impeller” refer to any apparatus that impels, moves, pushes, agitates, or otherwise directs and/or mixes projectiles within a loader or hopper, such as an agitator, arms, fins, paddles, paddle arms, spokes, drive cones, carriers, including, but not limited to, those shown and described in U.S. Pat. Nos. 6,213,110; 6,502,567; 5,947,100; 5,791,325; 5,954,042; 6,109,252; 6,889,680; and 6,792,933, the entire contents of which are incorporated by reference herein, and those used in commercially available paintball loaders such as the various HALO™ brand paintball loaders, the EMPIRE™ RELOADER paintball loaders, and substitutes or equivalents thereof.

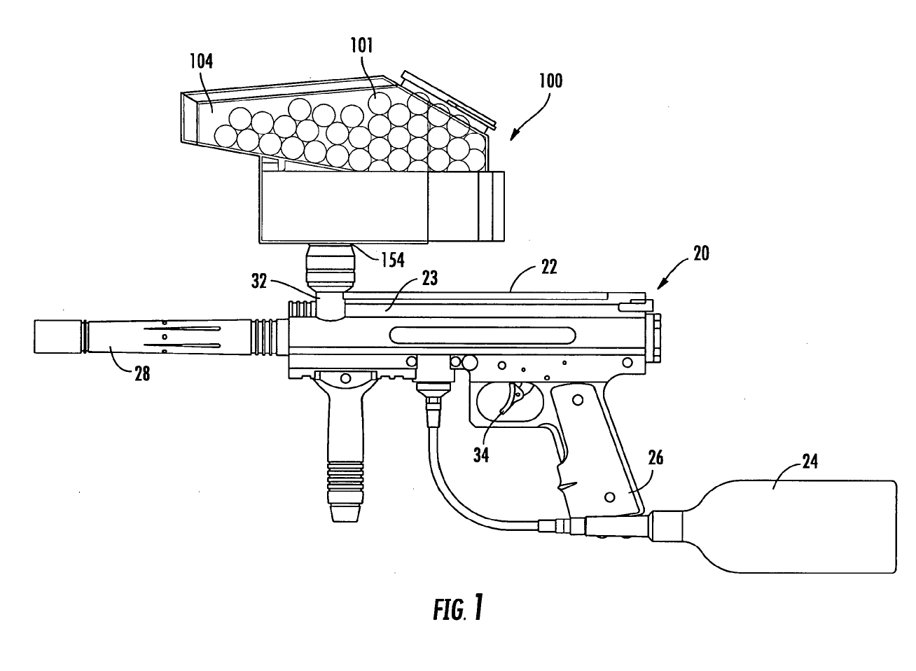

FIG. 1 is a side elevation view of a paintball loader 100 attached to a representative paintball marker 20. The paintball marker 20 includes a main body 22, a compressed gas cylinder (gas tank or air tank) 24, a barrel 28, and a grip portion 26. The paintball marker 20 also includes an inlet tube 32 (or feed neck) leading to a firing chamber 23 (or breech) in the interior of the main body 22, and a trigger 34 for firing the paintball marker 20. The compressed gas cylinder 24 is typically secured to a rear portion of the paintball marker 20 and normally contains CO₂ or NO₂, although any compressible gas may be used.

A plurality of paintballs 101 are stored in the loader 100, and are supplied to the breach 23 through a dispensing or outfeed tube 154 located at the bottom of the loader, and the inlet tube 32. When an operator of the paintball marker 20 squeezes trigger 34, the firing mechanism of the paintball marker 20 acts so that compressed gas from the compressed gas cylinder 24 is released and fires paintballs 101 located in the breech through the barrel 28.

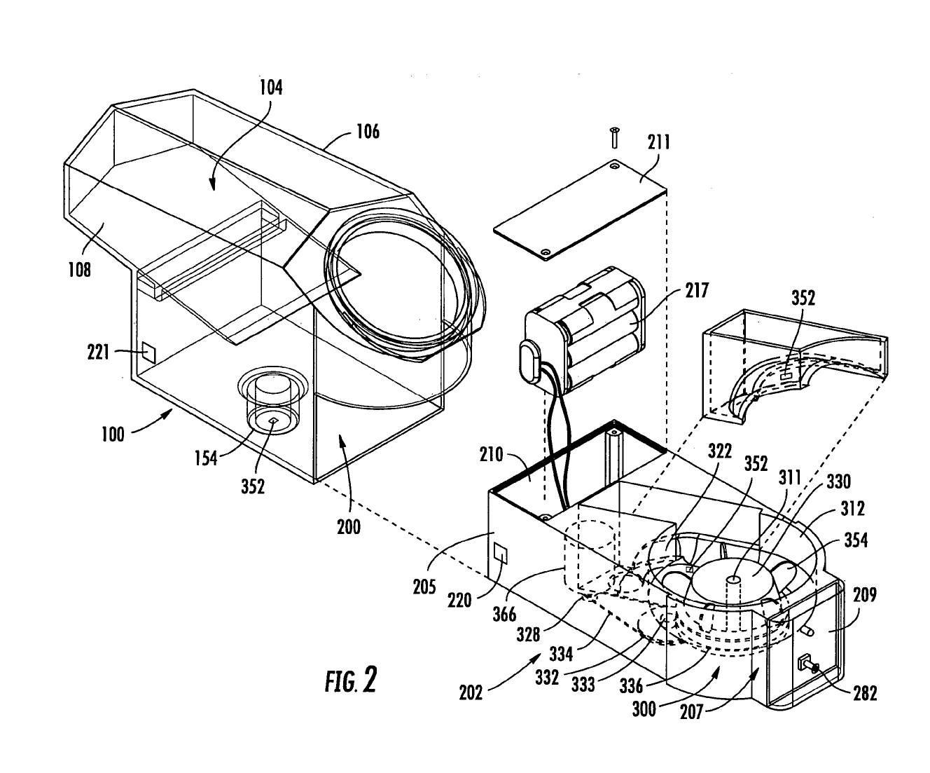

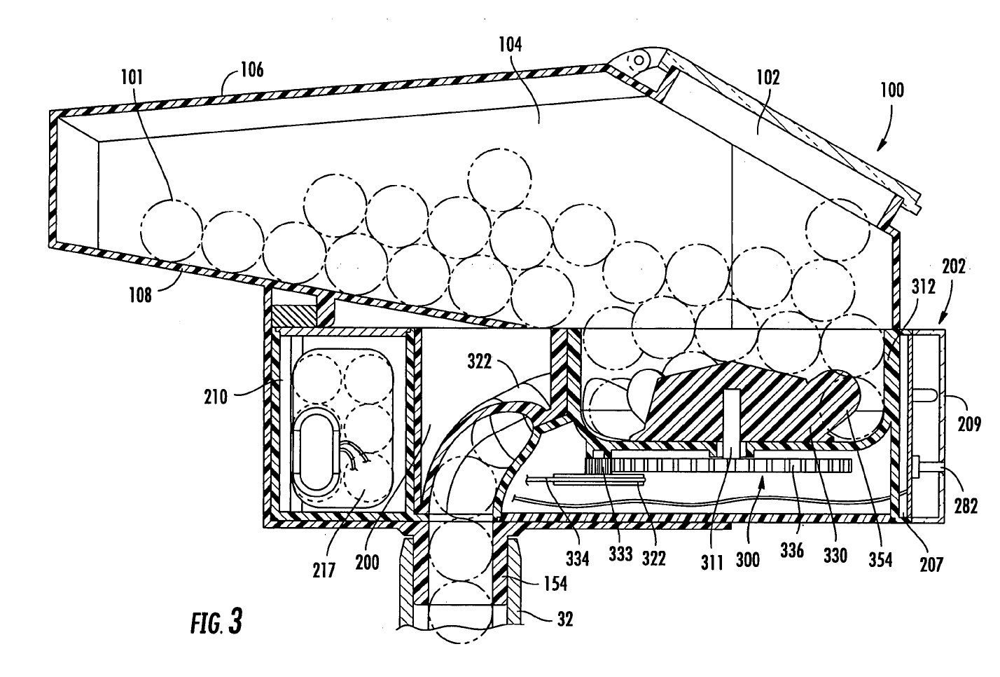

An embodiment of a paintball loader 100 of the present invention is shown in detail in FIGS. 2-3. The shell portion 106 of a paintball loader 100 according to the present invention includes an interior area 104 shaped to receive and store paintballs, a opening 102 so that paintballs can be loaded into the interior area 104, a dispensing tube 154, and a cartridge cavity 200 configured to receive a drive cartridge 202. An interior wall 108 may at least partially divide the interior area 104 from the cartridge cavity 200. The interior area 104 may be any size and shape that permits the paintballs 100 to move towards the cartridge 202 and/or dispensing tube 154. In use, a user loads paintballs 101 into the loader 100 through the opening 102 which are then stored in the interior area 104 until fed to a paintball marker.

The present invention provides a paintball loader 100 that is separable into a shell portion 106, and a removable drive cartridge 202 for housing components of the drive mechanism 303 of the paintball loader. The drive cartridge 202 includes a paintball drive assembly 300 which includes a feed mechanism or feeder 330 and drive motor 366. The motor 366 may be in communication with a controller 207 which may include circuitry and/or microprocessor for controlling at least one operation of the loader 100, for example, activating the feed mechanism 330 after a projectile is fired from the marker, adjusting the rate of feeding, or stopping the feed mechanism 330 in the event of a jammed projectile, an empty loader, or when a paintball marker with which the loader is communicating ceases firing. The controller 207 is preferably located behind a faceplate 209 or cover, and may be controlled by the user via at least one accessible button 282. The button 282 may also power the loader “ON” and “OFF”.

The drive cartridge 202 may include a compartment 210 in which the motor 366, a power source, such as a battery 217, for powering the motor 366, controller 107, or any combination thereof, is housed. In another embodiment, the controller 107 or any other components may also be stored within the compartment 210 to locate such components further inside the interior 104 of the loader 100.

The compartment 210 of the cartridge 202 may be accessible via an access door 211 when the cartridge 202 is removed from the cartridge cavity 200. The access door 211 is preferably located on the top surface 212 of the compartment 210.

The drive cartridge 202 is removably attached to the shell portion 106 by engaging elements 220, 221. The drive cartridge 202 is preferably secured to the cartridge cavity 200 of the loader 100 by engaging elements such as tabs 220 located on a front portion 205 of the cartridge 202 adjacent the shell portion 106 when assembled. The tabs 220 engage with complimentary slots 221 located on the loader 100, securing the cartridge 202 in place inside of the cavity 200. The cartridge 202 is released from the cavity 200 by compressing the tabs 202 so that they are removed from contact with the slots 221.

It is contemplated that the depressible tabs 220 and complimentary slots 221 can be replaced by alternate engaging elements to removably secure the cartridge 220 inside of the cavity 200. Other means for removably attaching the cartridge 202 to the loader 100 include magnets, snap fits, press fits, fasteners, flanges, or any other suitable means which facilitates efficient connection and removal of the cartridge 202.

FIGS. 2-4 show an exemplary cartridge 202 and drive assembly 300 of the present invention. The drive assembly 300 may be formed having a catch cup 312 positioned below a break in the interior wall 108 that accepts paintballs 101 from the interior paintball chamber 104 of the loader 100. The feed mechanism or feeder 330 is positioned into the catch cup 312, with its shaft 311 inserted through the cup 312.

In use, the feed mechanism 330 is designed to feed (move) projectiles from the catch cup 312 into the outfeed tube 322, which, when the cartridge is positioned and aligned properly in the cavity 200, is in communication with the dispensing tube 154 of the loader 100. It should be noted that the catch cup 312 and/or the outfeed tube 322 may be formed integrally with the cartridge 202, or may be separate components housed in the cartridge 202.

The feed mechanism 330 may be formed as a drive cone, a paddle wheel, an agitator, arms, fins, or any other element for mixing, moving, or stirring paintballs in the loader. The feed mechanism 330 may include a shaft 311, and rotation of the shaft 311 will rotate the feed mechanism 330.

The motor 366 is provided to drive the feed mechanism 330 via a drive assembly 300 including a gear, gears or gearbox. The motor 366 is mounted adjacent the catch cup 312 and may comprise, but is not limited to, for example, a DC motor, although any suitable motor or driving mechanism (such as a stepper motor) may be utilized without departing from the scope of the present invention. The motor 366 may be controlled by a controller 207, such as electronic control circuitry that may include a microprocessor. The paintball loader 100 may also include at least one sensor 352 in electrical or wireless communication with a motor 366 and/or controller 207 for detecting paintballs (such as by movement or position, for example) and/or movement or position of the feed mechanism 330. The sensor 352 may be an electro-mechanical sensor, a switch, an optical sensor, a break beam sensor, and infrared (IR) sensor, a reflective sensor, a sound or Shockwave sensor, a piezoelectric sensor, or any other sensor as are known in the art for detecting paintball or feeder movement. The controller 207 can control rotation of the motor 366 in any direction, providing for a reversal of the rotation of the feed mechanism 330 enhancing its ability to clear projectile jams.

In operation, the user may actuate the controller 207 via a switch plate 209 locate on the exterior of the cartridge 202, such as by pressing a button 282 on the switch plate 209 (FIG. 2). In one embodiment, at least one power source such as a battery 217 is provided to power the motor and/or additional controls or sensors. The battery 217 is preferably stored inside of the compartment 210 located in the drive cartridge 202.

In one embodiment, the drive assembly 300 comprises a belt and pulley system, with the motor operating a first pulley 328, the first pulley driving a drive belt 334, and the drive belt 334 driving a second pulley 332. The second pulley 332 comprises an integral pinion gear 333 configured to drive a spur gear 336. The shaft 311 of the feed mechanism 330 is preferably keyed into the spur gear 336, whereby the rotation of the spur gear 336 rotates the feed mechanism 330.

It is envisioned that this combination belt drive and gear arrangement could be replaced with any other suitable means to transmit the rotational force of the motor 366 to the feed mechanism 330 including direct, gear, belt, or fluid drives. It is also envisioned that the size of respective pulleys 328, 332 and gears 333, 336 could be varied in order to change the rotational speed of the feed mechanism 330, thereby varying the feed rate of the balls into the marker, as well as the torque delivered by the shaft 311. The motor 366 may also directly drive the shaft 311 of the feed mechanism 330, without the use of additional gears or belts. Any arrangement for coupling the motor to the drive shaft to operate the drive shaft is contemplated as included within the scope of the present invention.

The feed mechanism 330 may have a plurality of fins 354 that push and agitate the paintballs 101, however, the feed mechanism 330 however may include any arms (fins, paddles, or other extensions) such as those shown and described in U.S. Pat. Nos. 6,213,110; 6,502,567; 5,947,100; 5,791,325; 5,954,042; 6,109,252; 6,889,680; 6,701,907 and 6,792,933 the entire contents of which are incorporated fully by reference herein, which are used in connection with the well known HALO™ B or EMPIRE™ RELOADER B paintball loaders. It is noted that the present invention may be used with, in place of, or as an adjunct to any other feed mechanism, agitator, paddle or impeller of any kind.

FIG. 3 is a cross-section view of the loader 100 of the present invention as described above with respect to FIG. 2 with the drive cartridge 202 positioned within the cavity 200 of the loader 100, such as in use. The paintballs passing through the opening 102 of the loader 100 disperse through the interior area 104, as well as into the drive cartridge 202. In use, the feed mechanism 330, driven by the drive system 300, urges the paintballs 101 through the outfeed tube 322, through the dispensing tube 154, and into the inlet tube 32 of the paintball marker 20 for firing.

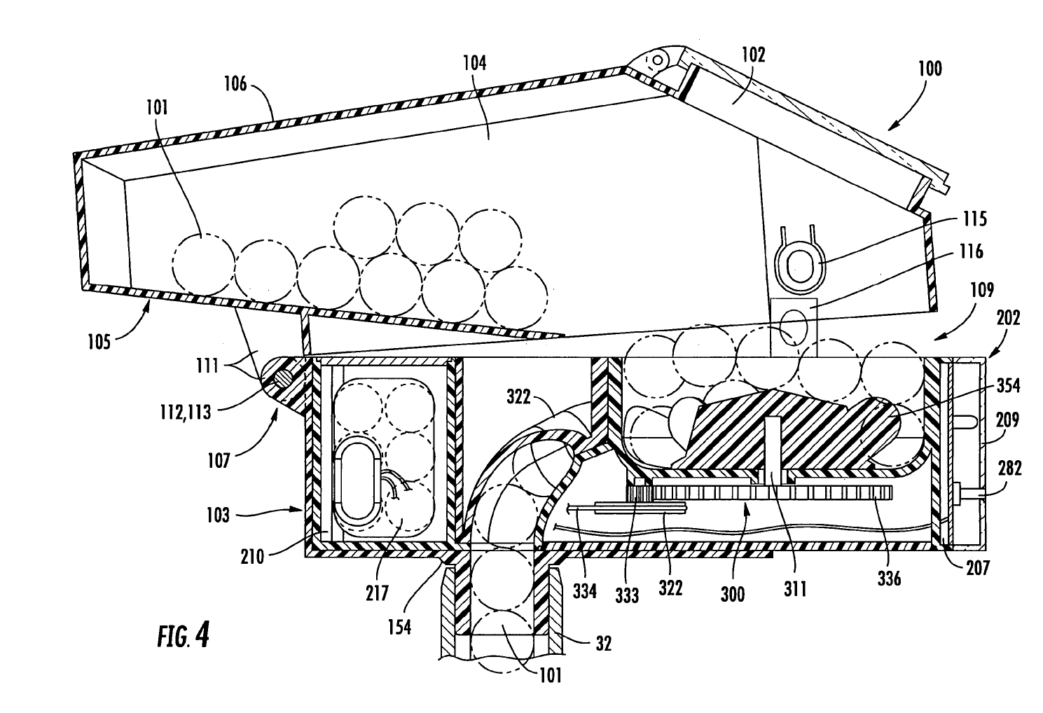

FIG. 4 shows a cross-section view of another embodiment of the present invention wherein a first portion 105 of the loader 100 is hingedly attached to a second portion 103 by a hinge 107, such that the first portion 105 can move relative to the second portion 103, to expose the drive cartridge 202 and/or drive mechanism 330 of the paintball loader 100, without completely disassembling the loader. The hinge 107 may be formed as complementary flanges 111 with openings 112 therethrough, and a pin 113 positioned through the openings 112, hingedly connecting the first portion 105 to the second portion 103. However, any suitable releasable mating means may be used.

The first and second portions 105 and 103 preferable comprise a securing means 115, 116, in order to secure the first and second portions in a closed state while the marker is in use. In a preferred embodiment, the securing means comprises depressible tabs 115 on the first portion 105 of the loader 100, and flanges 116 on the second portion 103 of the loader, configured to engagingly accept the depressible tab 115. Such an arrangement offers a quick and efficient means to quickly couple and decouple the first and second portions 105, 103 of the loader 100. It is envisioned that any suitable means to secure the first and second portions together may be used without departing from the scope of the present invention, including the use of magnets, friction fits, and other mechanical fasteners.

In the embodiment shown in FIG. 4, the drive cartridge 202 and/or drive mechanism 330 may be either removable or formed as an integral part of the second portion 103. A user can access the drive cartridge 202 and at least some of its component parts by detaching (if connected), lifting and pivoting the first portion 105 of the loader 100 away from the second portion 103. Once reoriented, the drive cartridge 202 can be removed or inspected through an opening 109 formed by the separation of the upper and lower portions 105, 103. This arrangement may also be utilize in conjunction with the above-described configuration wherein the cartridge is inserted generally horizontally into the cavity 200, thereby given the user several accessibility options to access the drive system.

It should be noted that in any of the above described embodiments, a drive cartridge 202 may be replaced in its entirety by a second different cartridge 202, allowing a user to quickly reconfigure the loader without replacing individual components of the drive assembly located within a given cartridge. For example, a first drive cartridge may have a first configuration, such as a drive assembly 300 configured in one manner, such as a certain feeder 330 with a particular motor 366 and first control circuit 207 having a first set of operating parameters. A second drive cartridge may have a second configuration, such as a drive assembly 300 configured in a second manner, with a different feeder 330, with a different motor 366 and different control circuit 207 having different operational parameters. The present invention makes it simple and efficient to swap out differently configured drive cartridges for the different needs of a user. By use of the present invention, a user may have several user-selectable set-ups that can be easily changes, based on the needs of a user.

In addition, a user may be given several different options for the shell portion 106 of the loader of the present invention. A use may be supplied with one or more drive cartridges 202, and several different shell portions 106, having different capacities for holding paintballs, different body shapes, different colors, different designs, different opening sizes, or formed from different materials. Accordingly, the present invention provides for a highly reconfigurable paintball loader system that may be configured to meet the user's needs.

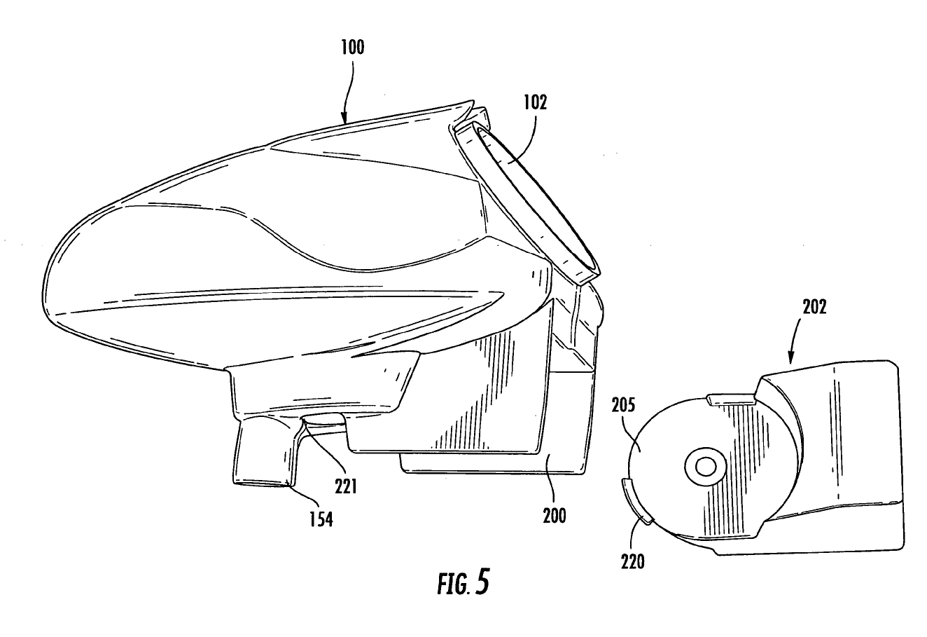

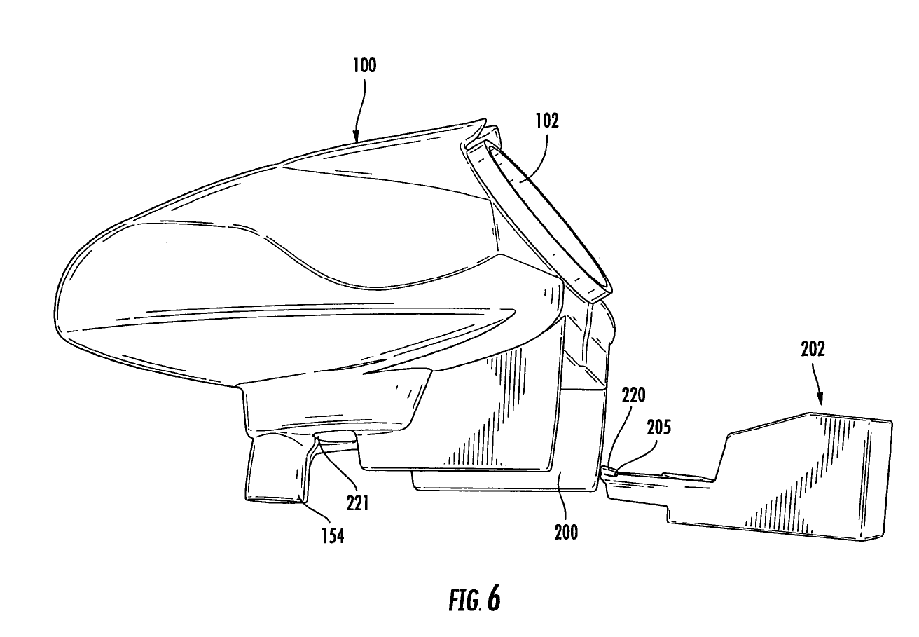

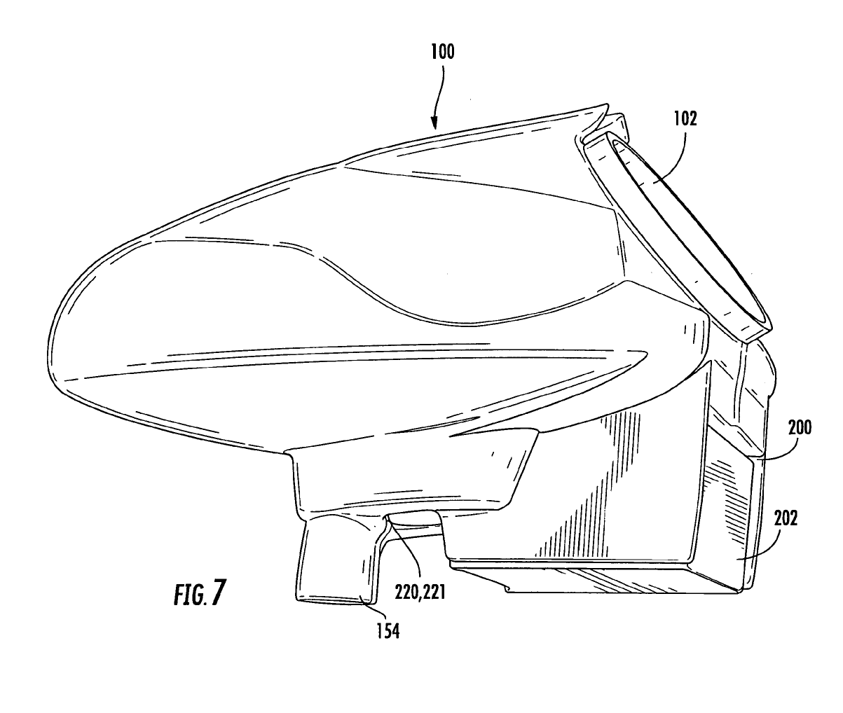

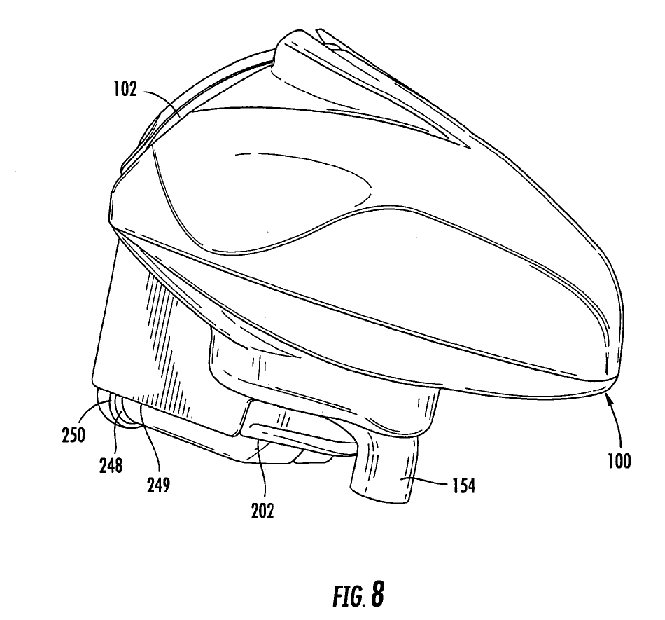

FIGS. 5-8 are views of an exemplary loader 100 of the present invention, showing attachment and removal of the cartridge 202 with the cavity 200 of the shell portion of a loader according to the present invention. As shown in FIG. 5, the loader 100 of the present invention utilizes a removable drive cartridge 202 having an engaging element 220 located on an end 205 of the cartridge 202. Complementary attachment points 221 are located within the cavity 200 of the loader 100. As shown in FIGS. 7 and 8, to insert the cartridge 202, the user aligns the cartridge with the cavity 200 of the loader 100. Once aligned, the cartridge 202 is inserted into the cavity 200 until a positive engagement is achieved between the attachment points 220 and 221. Removal of the cartridge 202 is accomplished by manipulating the attachment means 220, 221 in order to release the cartridge 202 from the loader 200.

It is appreciated that the cartridge shown in FIGS. 5-8 could receive any type or arrangement of drive system, such as any motor, feed mechanism, power supply, control circuitry, or other combination of those elements.

In one embodiment show in FIG. 8, the cartridge 202 is supported in the cavity 200 by means of a strap 250, rather than a bottom wall of the shell portion. The strap 250 extends generally across the bottom 249 of the cavity 200 and acts as a support for the cartridge 202. It is envisioned that the strap 250 may be integral formed with the shell portion, or may comprise a separate piece, fixed to the loader 100. Moreover, it is envisioned that the strap 250, in addition to supporting the cartridge 202, may comprise a complimentary shape to a portion 248 of the cartridge 202, providing for a snap or press-fit between the strap 250 and the cartridge 202, securing the cartridge to the loader 100. However, as described above, it is envisioned that the means to removably secure the cartridge 202 to the loader 100 can comprise any suitable method including magnetic and mechanical attachment connections without departing from the scope of the present invention. Additionally, the location of these attachment means can be varied on both the loader 100 and the cartridge 202.

Having thus described in detail several embodiments of the present invention, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiments are possible which do not alter, with respect to those parts, the inventive concepts and principles embodied therein. The present embodiments and optional configurations are therefore to be considered in all respects as exemplary and/or illustrative and not restrictive, the scope of the invention being indicated by the appended claims rather than by the foregoing description, and all other embodiments and changes to these embodiments which come within the meaning and range of equivalency of said claims are therefore to be embraced therein.

What is claimed is:

1. A paintball loader including a removable drive assembly, comprising:
a shell portion, the shell portion including an interior area for receiving paintballs, the shell portion including a cavity for receiving a cartridge;
a removable cartridge configured to be positioned within the cavity of the shell portion, the cartridge removably engaging the shell portion, the cartridge including a drive assembly for moving paintballs placed in the paintball loader;
the cartridge configured to be removed from the shell portion to allow access to the drive assembly.

2. The paintball marker and loader combination of claim 1, wherein the drive assembly comprises a feeder for moving paintballs and a motor communicating with the feeder.

3. A paintball loader comprising:
a first body portion, the first portion including an interior area for holding paintballs;
a second body portion, the second portion including a drive assembly for moving paintballs; and,
a hinge connecting the first portion and the second portion, the first portion configured to move relative to the second portion allowing access to the drive assembly.

4. The paintball loader of claim 3, wherein the second body portion includes a cavity for receiving a cartridge, the second portion further comprising a cartridge including the drive assembly.

5. The paintball loader of claim 4, wherein the cartridge is removable from the second portion.

6. The paintball loader of claim 5, wherein the drive assembly comprises a feeder for moving paintballs and a motor communicating with the feeder.

7. A method for accessing a drive assembly of a paintball loader comprising the steps of:
(a) providing a paintball loader having a shell portion defining interior area for receiving paintballs, the shell portion including a cavity for receiving a cartridge;
(b) providing a cartridge including a drive assembly for moving paintballs;
(c) removably engaging the cartridge and the shell portion;
(d) removing the cartridge from the shell portion; and,
(e) accessing the drive assembly.

8. The paintball marker and loader combination of claim 7, wherein the drive assembly comprises a feeder for moving paintballs and a motor communicating with the feeder.

9. A paintball loader kit, comprising:
a shell portion, the shell portion including an interior area for receiving paintballs, the shell portion including a cavity for receiving a cartridge;
a first cartridge, the first cartridge including a first drive assembly, the first drive assembly having a first configuration;
a second cartridge, the second cartridge including a second drive assembly, the second drive assembly having a configuration different than the first configuration;
wherein the first cartridge and the second cartridge are adapted to be received in the cavity of the shell portion, wherein the first cartridge and the second cartridge are removably engagable with the shell portion.

10. A paintball loader kit comprising:
a first shell portion, the first shell portion including an interior area for receiving paintballs, the first shell portion including a cavity for receiving a cartridge, the first shell portion having a first configuration;
a second shell portion, the second shell portion including an interior area for receiving paintballs, the second shell portion including a cavity for receiving a cartridge, the second shell portion having a second configuration; and,
a cartridge, the cartridge including a drive assembly, wherein the cartridge is configured to be positioned within the cavity of the first shell portion or the cavity of the second shell portion, wherein the cartridge is configured to removably engage either of the first shell portion or the second shell portion.
